(19) United States
(12) Patent Application Publication
(10) Pub. No.: US 2015/0053078 A1
(43) Pub. Date: Feb. 26, 2015

(54) BUBBLE REMOVAL APPARATUS, BUBBLE REMOVAL METHOD, AND CHEMICAL SUPPLY SYSTEM OF SEMICONDUCTOR MANUFACTURING APPARATUS

(71) Applicant: Kabushiki Kaisha Toshiba, Minato-ku (JP)

(72) Inventors: Takashi MOTOOKA, Yokkaichi-shi (JP); Atsuyuki Manabe, Yokkaichi-shi (JP)

(73) Assignee: Kabushiki Kaisha Toshiba, Minato-ku (JP)

(21) Appl. No.: 14/196,023

(22) Filed: Mar. 4, 2014

(30) Foreign Application Priority Data
Aug. 26, 2013 (JP) 2013-174919

(51) Int. Cl. B01D 19/02

(52) U.S. Cl. CPC B01D 19/02
USPC 95/46; 96/179; 96/6; 95/242

(57) ABSTRACT

According to one embodiment, a bubble removal apparatus includes a bubble adsorption unit and a bubble discharge unit. The bubble adsorption unit adsorbs bubbles in a liquid in a container filled with the liquid. The bubble discharge unit discharges bubbles from the container. The bubble adsorption unit includes a mesh structure. In the mesh structure, linear members are combined in a grid-like pattern. The mesh structure is configured by using the linear members including a charging member that can be charged positively.

### CROSS-REFERENCE TO RELATED APPLICATIONS

This application is based upon and claims the benefit of priority from Japanese Patent Application No. 2013-174919, filed on Aug. 26, 2013; the entire contents of which are incorporated herein by reference.

### FIELD

Embodiments described herein relate generally to a bubble removal apparatus, a bubble removal method, and a chemical supply system of a semiconductor manufacturing apparatus.

### BACKGROUND

A chemical such as a photoresist solution used in a manufacturing process of semiconductor products is filled in a chemical tank together with nitrogen gas and the like for quality retention. Nitrogen gas dissolves in the chemical in a form of fine bubbles (microbubbles) during a period while the chemical tank is transported and installed in a semiconductor manufacturing apparatus.

When the chemical containing such microbubbles is discharged from the chemical tank, microbubbles are separated from the chemical to generate large bubbles in a portion having a pressure drop or pressure release, of a path in which the chemical flows. When the chemical in which large bubbles are present is supplied to a wafer, application failure of the chemical, and further, a defect resulting from the application failure will occur. Therefore, microbubbles in the chemical discharged from the chemical tank affect the yield and reliability of the semiconductor products.

Conventionally, a technique for removing bubbles from a chemical to be supplied to a wafer has been known. However, as the semiconductor devices are downsized, a pressure loss tends to increase, and hence, it is difficult to sufficiently suppress the presence of bubbles in the chemical.

### BRIEF DESCRIPTION OF THE DRAWINGS

FIG. 1 illustrates a schematic configuration of a semiconductor manufacturing apparatus including a bubble removal apparatus according to an embodiment;

FIG. 2 schematically illustrates the configuration of the bubble removal apparatus;

FIG. 3 is an explanatory diagram of adsorption and discharge of bubbles by the bubble removal apparatus;

FIG. 4 is a schematic cross-sectional view explaining a principle of bubble flow to a mesh structure and a hollow fiber membrane;

FIG. 5 illustrates a configuration example of the mesh structure; and

FIG. 6 illustrates a modification of the bubble removal apparatus.

### DETAILED DESCRIPTION

In general, according to one embodiment, a bubble removal apparatus includes a bubble adsorption unit and a bubble discharge unit. The bubble adsorption unit adsorbs bubbles in a liquid in a container filled with the liquid. The bubble discharge unit takes in bubbles adsorbed by the bubble adsorption unit. The bubble discharge unit discharges the taken-in bubbles from the container. The bubble adsorption unit includes a mesh structure. In the mesh structure, linear members are combined in a grid-like pattern. The mesh structure is configured by using the linear members including a charging member that can be charged positively.

Exemplary embodiments of a bubble removal apparatus, a bubble removal method, and a chemical supply system of a semiconductor manufacturing apparatus will be explained below in detail with reference to the accompanying drawings. The present invention is not limited to the following embodiments.

### Embodiment

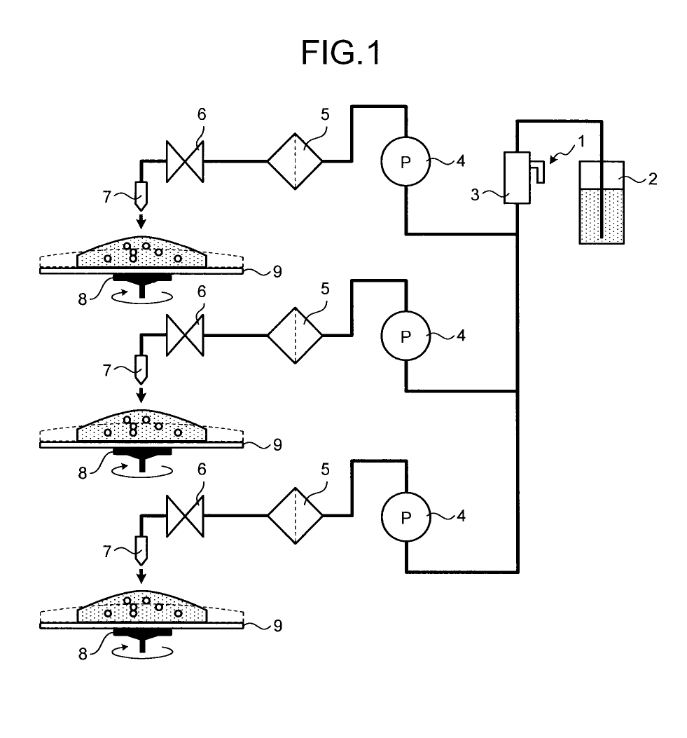

FIG. 1 illustrates a schematic configuration of a semiconductor manufacturing apparatus including a bubble removal apparatus according to an embodiment. A bubble removal apparatus 1 is applied to, for example, a chemical supply system of a semiconductor manufacturing apparatus. For example, the semiconductor manufacturing apparatus applies a chemical on a wafer 9. The chemical supply system supplies the chemical to the wafer 9. The chemical is, for example, a photoresist solution. The chemical can be any liquid to be applied on the wafer 9, other than the photoresist solution. The chemical can be, for example, an organic solvent.

The chemical supply system includes a chemical bottle 2, a liquid end (LE) tank 3, a supply pump 4, a filter 5, a valve 6, and a nozzle 7.

The chemical bottle 2 is a supply source of the chemical. The LE tank 3 is a container to temporarily store the chemical from the chemical tank 2. When there is no chemical left in the chemical bottle 2, the chemical bottle 2 is replaced while supply of the chemical stored in the LE tank 3 is continued. The LE tank 3 functions as a spare container at the time of replacement of the chemical bottle 2. The bubble removal apparatus 1 is attached to the LE tank 3.

The supply pump 4 supplies the chemical from the LE tank 3 to the nozzle 7. The filter 5 removes impurities and bubbles from the chemical. The valve 6 adjusts discharge of the chemical from the nozzle 7. The nozzle 7 discharges the chemical to the wafer 9 on a spin coater 8. The spin coater 8 rotates the wafer 9 at high speed, thereby applying the chemical discharged from the nozzle 7 onto the entire surface of the wafer 9.

FIG. 1 illustrates an example in which a pipe line for supplying the photoresist is branched into three lines from the LE tank 3 to apply the photoresist to the wafer 9 in three systems. The number of systems is arbitrarily determined.

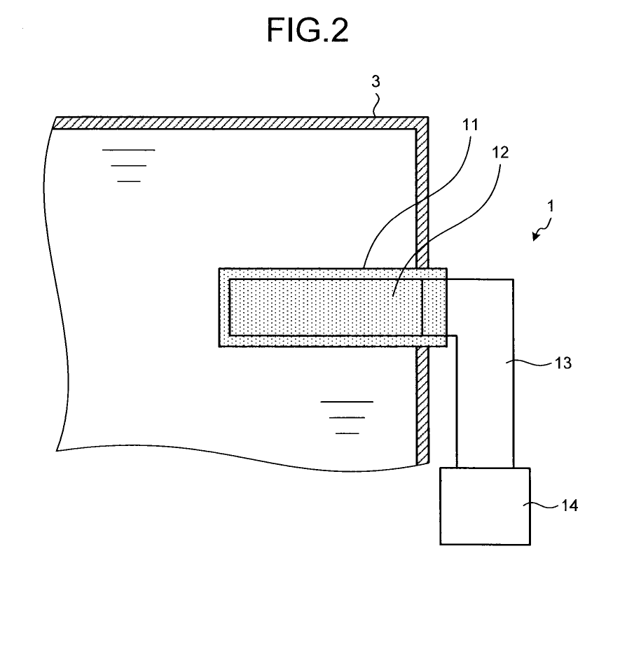

FIG. 2 schematically illustrates the configuration of the bubble removal apparatus. The bubble removal apparatus 1 includes a mesh structure 11, a hollow fiber membrane 12, and a discharge pipe 13.

The mesh structure 11 is provided while penetrating a sidewall of the LE tank 3. The mesh structure 11 is a bubble adsorption unit that adsorbs bubbles in the liquid in the container filled with the liquid. In the present embodiment, the mesh structure 11 adsorbs bubbles in the chemical in the LE tank 3 filled with the chemical. The mesh structure 11 is configured by combining linear members in a grid-like pattern.

The hollow fiber membrane 12 is provided inside the LE tank 3. The hollow fiber membrane 12 is the bubble discharge unit that takes in bubbles adsorbed by the bubble adsorption unit and discharges the taken-in bubbles from the container. In the present embodiment, the hollow fiber membrane 12 takes in bubbles adsorbed by the mesh structure 11 and discharges the taken-in bubbles from the LE tank 3. The mesh structure 11 is wound around the hollow fiber membrane 12.

The hollow fiber membrane 12 has a property of passing gas but not passing liquid. When the inner pressure of the hollow fiber membrane 12 is negative, the hollow fiber membrane 12 takes in the gas dissolved in liquid to separate the gas from the liquid.

The discharge pipe 13 is connected to the hollow fiber membrane 12. The discharge pipe 13 discharges the gas in the hollow fiber membrane 12 to outside of the LE tank 3. A vacuum pump 14 is connected to the discharge pipe 13. When the vacuum pump 14 is operated, the insides of the discharge pipe 13 and the hollow fiber membrane 12 become a negative pressure.

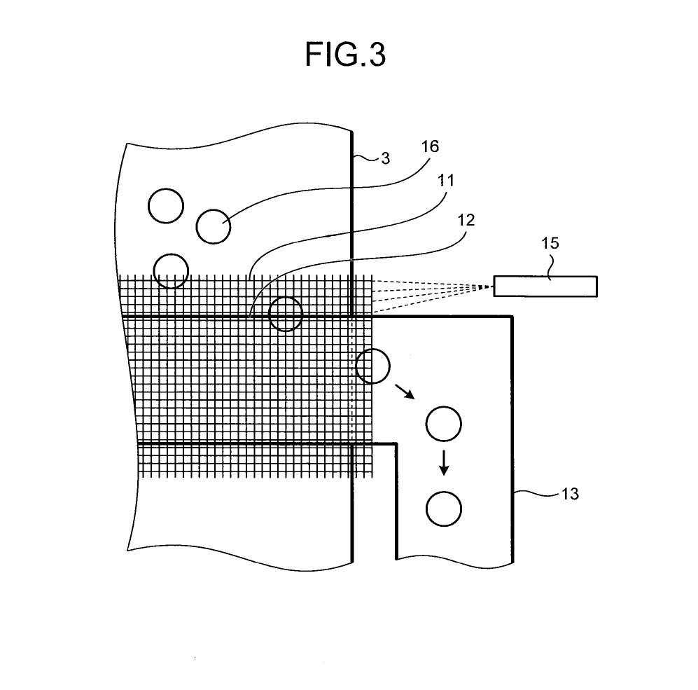

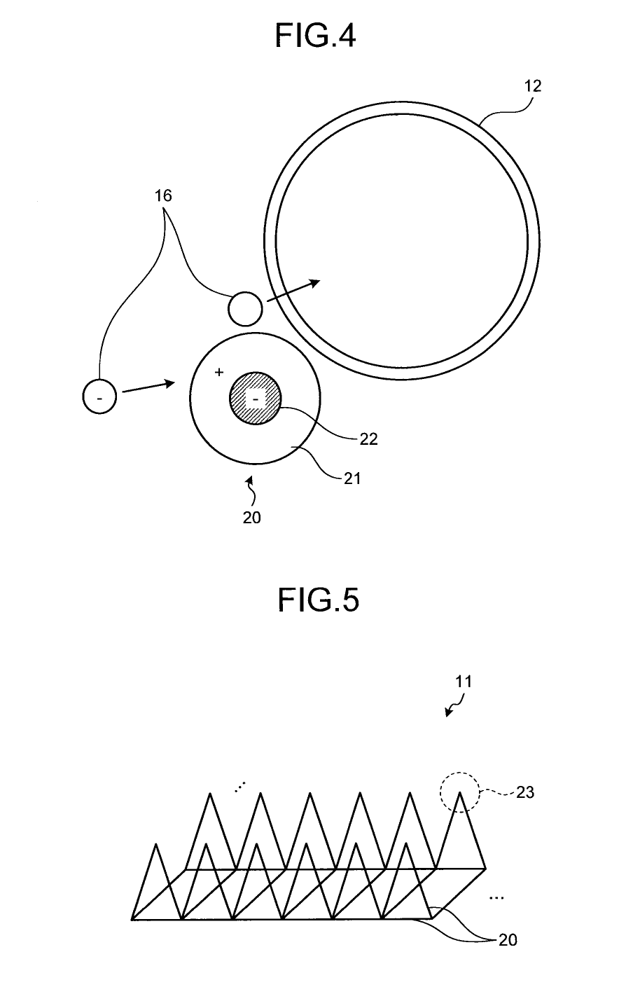

FIG. 3 is an explanatory diagram of adsorption and discharge of bubbles by the bubble removal apparatus. FIG. 4 is a schematic cross-sectional view explaining a principle of bubble flow to the mesh structure and the hollow fiber membrane. In FIG. 4, a cross-sectional configuration of the hollow fiber membrane 12 and a cross-sectional configuration of one linear member 20 constituting the mesh structure 11 are schematically shown.

The linear member 20 is configured by using a conductive substance 22 as a core and coating the conductive substance 22 with nylon 21. It is assumed that the conductive substance 22 is a metal member made of stainless steel or the like. The metal member can be made of any metal other than stainless steel. The nylon 21 is a charging member that is easily charged positively. Because the nylon 21 is coated on the conductive substance 22, corrosion of the metal member as the conductive substance 22 due to the chemical in the LE tank 3 is suppressed. The conductive substance 22 is exposed in a portion of the mesh structure 11, outside of the LE tank 3.

A charging gun 15 is a charging device that charges an object by corona discharge. The charging gun 15 forcibly causes the conductive substance 22 to be charged negatively by generating static electrical charge in the conductive substance 22. Because the conductive substance 22 is charged negatively, the nylon 21 is charged positively. It is desired that the bubble removal apparatus 1 charges the conductive substance 22, for example, regularly by using the charging gun 15.

Bubbles 16, which are microbubbles, are nitrogen gas dissolved in the chemical. The microbubbles have an aspect as colloidal particles, and it is known that the surface thereof is charged negatively. The bubbles 16 are attracted to the nylon 21 charged positively. Because electrostatic force acts between the nylon 21 and the bubbles 16, the bubbles 16 do not flow from the mesh structure 11 even when there is a chemical flow, and are retained on the surface of the mesh structure 11.

In this manner, the mesh structure 11 adsorbs the bubbles 16 in the chemical. The mesh structure 11 can efficiently adsorb the bubbles 16 by using the electrostatic force, regardless of the diameter size of the bubbles 16 with respect to the size of the grid formed by the linear members 20. It is assumed that the size of the grid can be appropriately designed.

The bubbles 16 are adsorbed by the mesh structure 11 and flow to near the hollow fiber membrane 12. The bubbles 16 are attracted to the hollow fiber membrane 12 having a negative pressure inside thereof, and are taken into the hollow fiber membrane 12. The bubbles 16 are discharged from the hollow fiber membrane 12 to the discharge pipe 13. Accordingly, the bubble removal apparatus 1 removes the bubbles 16 from the chemical.

The bubble removal apparatus 1 can effectively remove the microbubbles that are difficult to be removed by the filter 5. By removing the bubbles 16 in a stage where the chemical passes through the LE tank 3, the chemical supply system can suppress generation of bubbles in a portion having a pressure drop or pressure release on a downstream side of the LE tank 3.

Because the bubble removal apparatus can remove the microbubbles, which are the base of bubbles that affect application of the chemical, it is possible to effectively suppress the bubbles from mixing into the chemical supplied from the chemical supply system. Because the bubble removal apparatus removes bubbles in the stage of microbubbles, the presence of bubbles in the chemical can be sufficiently suppressed even under a condition in which a pressure loss increases along with the downsizing of the semiconductor device. The semiconductor manufacturing apparatus can suppress the presence of bubbles in the chemical, thereby reducing application failure of the chemical. The semiconductor manufacturing apparatus can reduce a defect resulting from the application failure of the chemical, and can improve the yield and reliability.

FIG. 5 illustrates a configuration example of the mesh structure. The linear members 20 constituting the mesh structure 11 are arranged in a grid-like pattern vertically and horizontally in a two-dimensional direction. Further, in the mesh structure 11, the linear members 20 are combined so as to form irregularities in a direction perpendicular to the two-dimensional direction. A protruding portion 23 of the irregularities is a tip portion at which the linear member 20 forms a sharp angle.

The protruding portion 23 is formed toward a direction opposite to the side of the hollow fiber membrane 12. In this manner, the mesh structure 11 includes the protruding portion 23 with the opposite side to the hollow fiber membrane 12 being convex. The mesh structure 11 attracts the bubbles 16 toward the tips of the protruding portions 23 so that the bubbles 16 are attached thereto. The mesh structure 11 can increase a surface area that comes in contact with the chemical by providing the protruding portions 23. Accordingly, the mesh structure 11 can efficiently adsorb the bubbles 16 by providing the protruding portions 23.

The shape and the configuration of the protruding portions 23 in the mesh structure 11 are not limited to those explained in the present embodiment. The protruding portions 23 can have any shape or any configuration, so long as the bubbles 16 can be attracted in the liquid.

The mesh structure 11 is not limited to the one including the linear members 20 coated with the nylon 21. The linear member 20 can include a charging member other than the nylon 21, so long as the microbubbles can be electrically adsorbed. By using the charging member that is easily charged positively, the mesh structure 11 can efficiently adsorb the bubbles 16.

The conductive substance 22 used as the core of the linear member 20 can be any substance having conductivity other than the metal member. For example, the linear member 20 can use carbon fiber as the conductive substance 22. In the mesh structure 11, the conductive substance 22 as a core can be omitted, so long as the bubbles 16 can be sufficiently adsorbed by the charging member. The bubble discharge unit needs only to take in bubbles from the liquid, and can include a member other than the hollow fiber membrane 12.

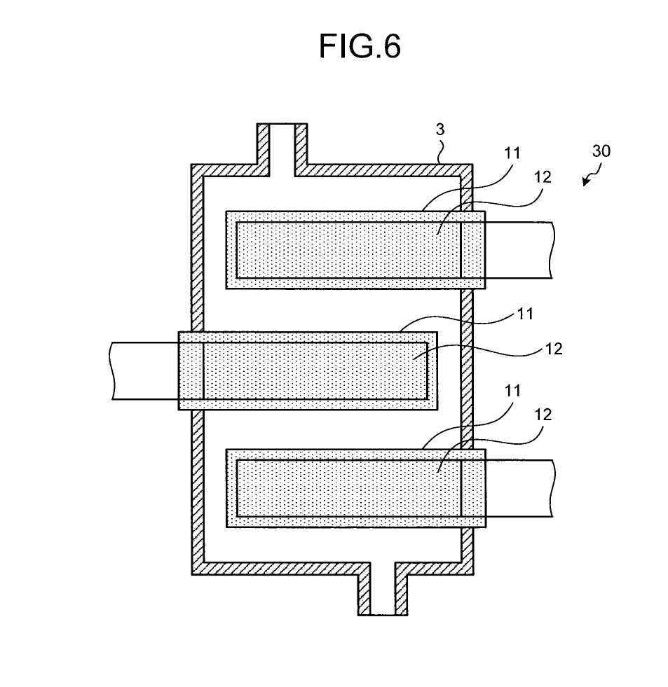

FIG. 6 illustrates a modification of the bubble removal apparatus. A bubble removal apparatus 30 according to the modification includes a plurality of hollow fiber membranes 12. The mesh structures 11 are wound around the respective hollow fiber membranes 12. The number of hollow fiber membranes 12 to be provided in the bubble removal apparatus 30 can be appropriately determined, taking the removal ability of the bubbles 16 of each hollow fiber membrane 12 into consideration.

The bubble removal apparatus can be provided not only in the LE tank 3, but also in any container or pipe line other than the LE tank 3 of the chemical supply system. When possibility of foreign matter contamination of the chemical after passing through the filter 5 is considered, it is desired that the bubble removal apparatus is provided at a position before the chemical flows through the filter 5.

In the chemical supply system, it is desired to remove the bubbles 16 as much as possible in a stage in which the bubbles are present as microbubbles, before the bubbles grow due to a pressure drop or pressure release. Therefore, it is desired that the bubble removal apparatus is provided at a position immediately after the chemical flows out from the chemical bottle 2. In the present embodiment, because microbubbles are formed by the gas for quality retention of the chemical, it is desired that the bubble removal apparatus removes the bubbles 16 at the time of using the chemical.

The bubble removal apparatus can be applied to any apparatus other than the chemical supply system of a semiconductor manufacturing apparatus. The bubble removal apparatus can be also an apparatus that removes bubbles from any liquid other than a chemical.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A bubble removal apparatus comprising:
a bubble adsorption unit that adsorbs bubbles in a liquid in a container filled with the liquid; and
a bubble discharge unit that takes in bubbles adsorbed by the bubble adsorption unit and discharges taken-in bubbles from the container, wherein
the bubble adsorption unit includes a mesh structure in which linear members are combined in a grid-like pattern, and
the mesh structure is configured by using the linear members including a charging member that can be charged positively.

2. The bubble removal apparatus according to claim 1, wherein the linear member is formed by coating a core made of a conductive substance with the charging member.

3. The bubble removal apparatus according to claim 1, wherein the charging member is nylon.

4. The bubble removal apparatus according to claim 1, wherein the bubble discharge unit includes a hollow fiber membrane that separates bubbles in the liquid from the liquid.

5. The bubble removal apparatus according to claim 4, wherein the mesh structure is wound around the hollow fiber membrane.

6. The bubble removal apparatus according to claim 4, wherein the mesh structure includes a protruding portion with an opposite side to the hollow fiber membrane being convex.

7. A bubble removal method comprising:
causing a mesh structure in which linear members are combined in a grid-like pattern to adsorb bubbles in a liquid in a container filled with the liquid; and
taking in bubbles adsorbed by the mesh structure and discharging taken-in bubbles from the container, wherein
the mesh structure is configured by using the linear members including a charging member that can be charged positively.

8. The bubble removal method according to claim 7, wherein the linear member is formed by coating a core made of a conductive substance with the charging member, and
the charging member is charged positively by charging the conductive substance negatively.

9. The bubble removal method according to claim 7, wherein bubbles in the liquid are adsorbed by the mesh structure configured to include nylon as the charging member.

10. The bubble removal method according to claim 7, wherein bubbles adsorbed by the mesh structure are taken into a hollow fiber membrane, and bubbles taken into the hollow fiber membrane are discharged from the container.

11. The bubble removal method according to claim 10, wherein bubbles in the liquid are adsorbed by the mesh structure wound around the hollow fiber membrane.

12. The bubble removal method according to claim 10, wherein bubbles in the liquid are adsorbed by the mesh structure including a protruding portion with an opposite side to the hollow fiber membrane being convex.

13. A chemical supply system that supplies a chemical to a wafer, in a semiconductor manufacturing apparatus that applies the chemical to the wafer, the chemical supply system comprising a bubble removal apparatus that removes bubbles from the chemical, wherein
the bubble removal apparatus includes
a bubble adsorption unit that adsorbs bubbles in the chemical in a container filled with the chemical, and
a bubble discharge unit that takes in bubbles adsorbed by the bubble adsorption unit and discharges the taken-in bubbles from the container,
the bubble adsorption unit includes a mesh structure in which linear members are combined in a grid-like pattern, and
the mesh structure is configured by using the linear members including a charging member that can be charged positively.

14. The chemical supply system of a semiconductor manufacturing apparatus according to claim 13, comprising:
a chemical bottle as a supply source of the chemical; and
a liquid end tank as the container that temporarily stores the chemical from the chemical bottle, wherein
the bubble removal apparatus is attached to the liquid end tank.

15. The chemical supply system of a semiconductor manufacturing apparatus according to claim 13, wherein the mesh structure is provided while penetrating a sidewall of the container.

16. The chemical supply system of a semiconductor manufacturing apparatus according to claim 13, wherein the linear member is formed by coating a core made of a conductive substance with the charging member.

17. The chemical supply system of a semiconductor manufacturing apparatus according to claim 13, wherein the bubble discharge unit includes a hollow fiber membrane that separates bubbles in the liquid from the liquid.

18. The chemical supply system of a semiconductor manufacturing apparatus according to claim 17, wherein a discharge pipe, for discharging gas in the hollow fiber membrane to outside of the container is connected to the hollow fiber membrane.

19. The chemical supply system of a semiconductor manufacturing apparatus according to claim 15, wherein nylon as the charging member is coated on a core made of a conductive substance in an inner portion of the container of the mesh structure.

20. The chemical supply system of a semiconductor manufacturing apparatus according to claim 15, wherein a core made of a conductive substance is exposed in a portion of the mesh structure, outside of the container.
